(19) United States
(12) Patent Application Publication
(10) Pub. No.: US 2010/0292092 A1
(43) Pub. Date: Nov. 18, 2010

(54) ANTIBODY FORMULATIONS

(76) Inventors: Charlene E. Brisbane, King of Prussia, PA (US); Tiffany Derrick, King of Prussia, PA (US); James P. Ludlow, King of Prussia, PA (US); Melissa Ann Shuman, King of Prussia, PA (US); Ping-Yang Y. Yeh, San Diego, CA (US)

Correspondence Address: GlaxoSmithKline;GLOBAL PATENTS -US, UW2220, P. O. BOX 1539, KING OF PRUSSIA, PA, 19406-0939, US

(21) Appl. No.: 12/664,777

(22) PCT Filed: Jun. 13, 2008
(86) PCT No.: PCT/US08/66816

§ 371 Date: Jun. 30, 2010

Related U.S. Application Data
(60) Provisional application No. 60/944,133, filed on Jun. 15, 2007.

(51) Int. Cl. C40B 30/04

(52) U.S. Cl. 506/9

(57) ABSTRACT

This invention relates to a method for high throughput protein formulations.

### FIELD OF THE INVENTION

This invention relates to a method for high throughput protein formulations.

### BACKGROUND OF THE INVENTION

Proteins are larger and more complex than traditional organic and inorganic drugs (i.e. possessing multiple functional groups in addition to complex three-dimensional structures), the formulation of such proteins poses special problems. For a protein to remain biologically active, a formulation must preserve the intact conformational integrity of at least a core sequence of the protein's amino acids while at the same time protecting the protein's multiple functional groups from degradation. Degradation pathways for proteins can involve chemical instability (i.e. any process which involves modification of the protein by bond formation of cleavage resulting in a new chemical entity) or physical instability (i.e. changes in the higher order structure of the protein). Chemical instability can result from deamidation, racemization, hydrolysis, oxidation, beta elimination or disulfide exchange. Physical instability can result from denaturation, aggregation, precipitation or adsorption, for example. The three most common protein degradation pathways are protein aggregation, deamidation and oxidation. Cleland et al. Critical Reviews in Therapeutic Drug Carrier Systems 10(4): 307-377 (1993).

There is a need for formulating stable pharmaceutical formulations via a high throughput method comprising proteins or monoclonal antibodies that are suitable for therapeutic use.

### SUMMARY OF THE INVENTION

The present invention relates to a high throughput formulation (HTF) technology for proteins and monoclonal antibodies (Mabs).

This invention is not to be limited in scope by the specific embodiments described herein. Indeed, various modifications of the invention in addition to those described herein will become apparent to those skilled in the art from the foregoing description. Such modifications are intended to fall within the scope of the appended claims.

Although one embodiment is for determining formulations, the present invention can also be used to determine formulations for, but not limited to, proteins, antibodies, monoclonal antibodies, polyclonal antibodies, or fragments of monoclonal or polyclonal antibodies.

In one embodiment, the present invention relates to a method for determining formulations comprising, a) providing a plurality of different test formulations; b) programming a robotic liquid handling system that manufactures the plurality of different test formulations; c) adding a protein to the plurality of different test formulations; d) simultaneously measuring multiple parameters and conditions of the protein; and e) selecting at least one test formulation that maintains protein stability after a stress condition. In another embodiment, the present invention relates to a method for determining formulations, wherein the protein is a protein fragment. In yet another embodiment, the present invention relates to a method for determining formulations, wherein the protein is a monoclonal antibody.

In another embodiment, the present invention relates to a method for determining formulations, wherein the plurality of different test formulations comprises at least 10 different formulations. In another embodiment, the present invention relates to a method for determining formulations, wherein the plurality of different test formulations comprises at least 48 different formulations. In yet another embodiment, the present invention relates to a method for determining formulations, wherein the plurality of different test formulations comprises at least 96 different formulations. In another embodiment, the present invention relates to a method for determining formulations, wherein the plurality of different test formulations comprises at least 384 different formulations. In another embodiment, the present invention relates to a method for determining formulations, wherein the plurality of different test formulations comprises at least 1536 different formulations.

In another embodiment, the present invention relates to a method for determining protein formulations comprising, a) imputing formulation parameters into a statistical program to design a plurality of different test formulations; b) programming a robotic liquid handling system that manufactures a first set of a plurality of different test formulations and a second set of a plurality of different test formulations; c) adding a protein to the first set of a plurality of different test formulations; d) adding a protein to the second set of a plurality of different test formulations; e) simultaneously exposing the first set of a plurality of different test formulations containing protein to stress conditions; f) simultaneously measure multiple parameters and conditions of the first set of a plurality of different test formulations containing protein after exposure to the stress conditions; g) simultaneously measure multiple parameters and conditions of the second set of a plurality of different test formulations containing protein; h) comparing the measurements from step f) to the measurements from step g); and i) selecting at least one test formulation that maintains protein stability after a stress condition.

It is to be understood that both the foregoing summary description and the following detailed description are exemplary and explanatory, and are intended to provide further explanation of the invention as claimed.

### DETAILED DESCRIPTION OF THE INVENTION

The present invention relates to a High Throughput Formulation (HTF) technology for proteins and monoclonal antibodies (Mabs). With the continued increase in the number of biopharmaceutical therapeutics under development, there is a need for reducing the formulation development cycle time needed to bring these products into the clinic and the commercial market. One embodiment of the present invention relates to a HTF method developed to enable rapid experimental screening and selection of formulations while enhancing the skilled artisan's knowledge of the formulation design space in terms of defining acceptable ranges of formulation ingredients.

In another embodiment of the invention, the method incorporates a Design of Experiments (DOE) approach to screen 384 unique formulations within a set of four 96-well plates. One skilled in the art can appreciate that the capacity of samples is not limited to 96 or even 384 wells. The capacity can be modified depending on the available space and/or technology employed, such as 96 well plates, 384 well plates, and so forth. Adaptable DOE software applications are available through Stat-Ease, Inc., Minneapolis, Minn. Logical substitutions for Stat-Ease, Inc.'s applications can include, but are not limited to JMP™ software, JMP™ is a business division of SAS® (Statistical Analysis Software) and Minitab™ softwares, all of which offer DOE applications.

In yet a further embodiment of the invention, the handling and manipulations of these unique formulations under various experimental conditions can be accomplished by employing a TECAN® robotic liquid handling system, or capable substitute. Following full buffer exchange within individual wells, the test formulations are analyzed using methods such as protein concentration determination via a UV-Visible method (A₂₈₀ₙₘ), pH analysis, size exclusion chromatography (SEC), dynamic light scattering (DLS), capillary isoelectric focusing (cIEF), Fluorescence, and differential scanning calorimetry (DSC); all of which are methods amenable to plate-based high throughput analysis.

In another embodiment, the HTF approach was verified using a pharmaceutically relevant Mab. Many formulations were eliminated, however, several lead formulations were identified using this HTF approach. Among the unpredictable issues and challenges encountered included the determination of an appropriate stress condition for Mabs and management, integration and automated analysis of the immense data sets generated from the multiple analytical methods.

The present HTF invention clearly offers significant advantages over conventional formulation development. Because multiple parameters and conditions are analyzed simultaneously using a parallel approach, this technology can enable a rapid identification of formulations which provide acceptable protein stability, as well as provide a thoroughly explored and well defined design space to aid in final formulation (because the skilled artisan is now able to screen so many variables and ranges, they can formulate the break points for the formulation ingredients, these break points define the design space of the final formulation during manufacturing and processing), selection and justification of product specifications.

In the description of the present invention, certain terms are used as defined below.

The term “protein formulation” or “antibody formulation” refers to preparations which are in such form as to permit the biological activity of the active ingredients to be unequivocally effective, and which contain no additional components which are toxic to the subjects to which the formulation would be administered.

“Pharmaceutically acceptable” excipients (vehicles, additives) are those which can reasonably be administered to a subject mammal to provide an effective dose of the active ingredient employed. For example, the concentration of the excipient is also relevant for acceptability for injection.

A “stable” formulation is one in which the protein therein essentially retains its physical and/or chemical stability and/or biological activity upon storage. Various analytical techniques for measuring protein stability are available in the art and are reviewed in Peptide and Protein Drug Delivery, 247-301, Vincent Lee Ed., Marcel Dekker, Inc., New York, N.Y., Pubs (1991) and Jones, A. Adv. Drug Delivery Rev. 10: 29-90 (1993), for example. Stability can be measured at a selected temperature for a selected time period. Preferably, the formulation is stable at ambient temperature or at 40° C. for at least 1 month and/or stable at 2-8° C. for at least 1 to 2 years. Furthermore, it is desirable that the formulation be stable following freezing (e.g. to −70° C.) and thawing of the product.

A protein “retains its physical stability” in a biopharmaceutical formulation if it shows little to no change in aggregation, precipitation and/or denaturation as observed by visual examination of color and/or clarity, or as measured by UV light scattering (measures visible aggregates) or size exclusion chromatography (SEC). SEC measures soluble aggregates that are not necessarily a precursor for visible aggregates.

A protein “retains its chemical stability” in a biopharmaceutical formulation, if the chemical stability at a given time is such that the protein is considered to retain its biological activity as defined below. Chemically degraded species may be biologically active and chemically unstable. Chemical stability can be assessed by detecting and quantifying chemically altered forms of the protein. Chemical alteration may involve size modification (e.g. clipping) which can be evaluated using SEC, SDS-PAGE and/or matrix-assisted laser desorption ionization/time-of-flight mass spectrometry (MALDI/TOF MS), for example. Other types of chemical alteration include charge alteration (e.g. occurring as a result of deamidation) which can be evaluated by ion-exchange chromatography, for example.

An antibody “retains its biological activity” in a pharmaceutical formulation, if the biological activity of the antibody at a given time is within about 10% (within the errors of the assay) of the biological activity exhibited at the time the pharmaceutical formulation was prepared as determined in an antigen binding assay, for example. Other “biological activity” assays for antibodies are elaborated herein below.

The term “isotonic” means that the formulation of interest has essentially the same osmotic pressure as human blood. In one embodiment, the isotonic formulations of the invention will generally have an osmotic pressure in the range of 250 to 350 mOsm. In other embodiments, isotonic formulations of the invention will have an osmotic pressure from about 350 to 450 mOsm. In yet another embodiment, isotonic formulations of the invention will have an osmotic pressure above 450 mOsm. Isotonicity can be measured using a vapor pressure or ice-freezing type osmometer for example.

As used herein, “buffer” refers to a buffered solution that resists changes in pH by the action of its acid-base conjugate components. In one embodiment, the buffer of this invention has a pH in the range from about 4.5 to about 6.0; in another embodiment, from about 4.8 to about 5.8; and a further embodiment, a pH of about 5.5. Examples of buffers that will control the pH in this range include acetate (e.g. sodium acetate), succinate (such as sodium succinate), gluconate, histidine, citrate and other organic acid buffers. Where a freeze-thaw stable formation is desired, the buffer is preferably not phosphate.

In a pharmacological sense, in the context of the present invention, a “therapeutically effective amount” of an antibody refers to an amount effective in the prevention or treatment of a disorder for the treatment of which the antibody is effective. A “disorder” is any condition that would benefit from treatment with the antibody. This includes chronic and acute disorders or diseases including those pathological conditions which predispose the mammal to the disorder in question.

A “preservative” is a compound which can be included in the formulation to essentially reduce bacterial action therein, thus facilitating the production of a multi-use formulation, for example. Examples of potential preservatives include octadecyldimethylbenzyl ammonium choride, hexamethonium chloride, benzalkonium chloride (a mixture of alkylbenzyldimethylammonium chlorides in which the alkyl groups are long-chain compounds), and benzelthonium chloride. Other types of preservatives include aromatic alcohols such as phenol, butyl and benzyl alcohol, alkyl parabens such as methyl or propyl paraben, catechol, resorcinol, cyclohexanol, 3-pentanol, and m-cresol. The most preferred preservation herein is benzyl alcohol.

The term “antibody” is used in the broadest sense and specifically covers monoclonal antibodies (including full length monoclonal antibodies), polyclonal antibodies, multispecific antibodies (e.g. bispecific antibodies), and antibody fragments so long as they exhibit the desired biological activity.

“Activity fragments” comprise a portion of a full length antibody, generally the antigen binding or variable region thereof. Examples of antibody fragments include Fab, Fab′, F(ab′)₂, and Fv fragments; diabodies; linear antibodies; single-chain antibody molecules; and multispecific antibodies formed from antibody fragments.

The term “monoclonal antibody” as used herein refers to an antibody obtained from a population of substantially homogeneous antibodies, i.e., the individual antibodies comprising the population are identical except for possible naturally occurring mutations that may be present in minor amounts. Monoclonal antibodies are highly specific, being directed against a single antigenic site. Furthermore, in contrast to conventional (polyclonal) antibody preparations which typically include different antibodies directed against different determinants (epitopes), each monoclonal antibody is directed against a single determination on the antigen. The modifier “monoclonal” indicates the character of the antibody as being obtained from a substantially homogeneous population of antibodies, and is not to be construed as requiring production of the antibody by any particular method. For example, the monoclonal antibodies to be used in accordance with the present invention may be made by the hybridoma method first described by Kohler et al., Nature 256:495 (1975), or may be made by recombinant DNA methods (see, e.g., U.S. Pat. No. 4,816,567). The “monoclonal antibodies” may also be isolated from phage antibody libraries using the technique described in Clackson et al., Nature 352:624-626 (1991) and Marks et al., J. Mol. Biol. 222:581-597 (1991), for example.

Themonoclonal antibodies herein specifically include “chimeric” antibodies (immunoglobulins) in which the portion of the heavy and/or light chain is identical with or homologous to corresponding sequences in antibodies derived from a particular species or belonging to a particular antibody class or subclass, while the remainder of the chain(s) is identical with or homologous to corresponding sequences in antibodies derived from another species or belonging to another antibody class or subclass, as well as fragments of such antibodies, so long as they exhibit the desired biological activity (U.S. Pat. No. 4,816,567; and Morrison et al., Proc. Natl. Acad. Sci. USA 81:6851-6855 (1984)).

The term “hypervariable region” when used herein refers to the amino acid residues of an antibody which are responsible for antigen-binding. The hypervariable region comprises amino acid residues from a “complementarity determining region” or “CDR” (i.e. residues 24-34 (L1), 50-58 (L2) and 89-97 (L3) in the light chain variable domain and 31-35 (H1), 50-65 (H2) and 95-102 (H3) in the heavy chain variable domain; Kabat et al., Sequences of Proteins of Immunological Interest, 5th Ed. Public Health Service, National Institutes of Health, Bethesda, Md. (1991)) and/or those residues from a “hypervariable loop” (i.e. residues 26-32 (L1), 50-52 (L2) and 91-96 (L3) in the light chain variable domain and 26-32 (H1), 53-55 (H2) and 96-101 (H3) in the heavy chain variable domain. Chothia and Lesk J. Mol. Biol. 196:901-917 (1987)). “Framework” or “FR” residues are those variable domain residues other than the hypervariable region residues as herein defined. The CDR and FR residues of the H52 antibody of the example below are identified in Elgenbrot et al. Proteins: Structure, Function and Genetics 18:49-62 (1994).

“Humanized” forms of non-human (e.g., murine) antibodies are chimeric antibodies which contain minimal sequence derived from non-human immunoglobulin. For the most part, humanized antibodies are human immunoglobulins (recipient antibody) in which residues from a hypervariable region of the recipient are replaced by residues from a hypervariable region of a non-human species (donor antibody) such as mouse, rat, rabbit or nonhuman primate having the desired specificity, affinity, and capacity. In some instances, FR residues of the human immunoglobulin are replaced by corresponding non-human residues. Furthermore, humanized antibodies may comprise residues which are not found in the recipient antibody or in the donor antibody. These modifications are made to further refine antibody performance in general, the humanized antibody will comprise substantially all of at least one, and typically two, variable domains, in which all or substantially all of the hypervariable regions correspond to those of a non-human immunoglobulin and all or substantially all of the FR regions are those of a human immunoglobulin sequence. The humanized antibody optionally also will comprise at least a portion of an immunoglobulin constant region (Fc), typically that of a human immunoglobulin. For further details, see Jones et al., Nature 321:522-525 (1986); Riechmann et al., Nature 332:323-329 (1988); and Presta, Curr. Op. Struct. Biol. 2:593-596 (1992).

“Single-chain Fv” or “sFv” antibody fragments comprise the V_{H} and V_{L} domain of antibody, wherein these domains are present in a single polypeptide chain. Generally, the Fv polypeptide further comprises a polypeptide linker between the V_{H} and V_{L} domains which enables the SFv to form the desired structure for antigen binding. For a view of sFv see Pluckthun in The Pharmacology of Monoclonal Antibodies, vol. 113, Rosenburg and Moore eds. Springer-Verlag, N.Y., pp. 269-315 (1994).

The term “diabodies” refers to small antibody fragments with two antigen-binding sites, which fragments comprise a heavy chain variable domain (V_{H}) connected to a light chain variable domain (V_{L}) in the same polypeptide chain (V_{H} and V_{L}). By using a linker that is too short to allow pairing between the two domains on the same chain, the domains are forced to pair with the complementary domains of another chain and create two antigen-binding sites. Diabodies are described more fully in, for example, EP 404,097; WO 93/11161; and Hollinger et al., Proc. Natl. Acad. Sci. USA 90:6444-6448 (1993).

The expression “linear antibodies” when used throughout the application refers to the antibodies described in Zapata et al. Protein Eng. 8(10):1057-1062 (1995). Briefly, these antibodies comprise a pair of tandem Fd segments (V_{H}-C_{H}-V _{H1}-C_{H1}) which form a pair of antigen binding regions. Linear antibodies can be bispecific or monospecific.

The antibody which is formulated is preferably essentially pure and desirable essentially homogenous (i.e. free from contaminating proteins etc). “Essentially pure” antibody means a composition comprising at least about 90% by weight of the antibody, based on total weight of the composition, preferably at least about 95% by weight. “Essentially homogeneous” antibody means a composition comprising at least about 99% by weight of antibody, based on total weight of the composition.

“Treatment” refers to both therapeutic treatment and prophylactic or preventative measures. Those in need of treatment include those already with the disorder as well as those in which the disorder is to be prevented.

“Mammal” for purposes of treatment refers to any animal classified as a mammal, including but not limited to humans, domestic and farm animals, and zoo, sports, or pet animals, such as dogs, horses, cats, and cows.

“Stress condition” refers to an environment which is chemically and physically unfavorable for a protein and may render unacceptable protein stability, for example, thermal, shear, or chemical stress conditions.

UV-Vis spectrophotometry is a method used to calculate protein concentration from the absorbance at 280 nm. It is also used to monitor protein aggregation events via optical density measurements at 360 nm.

Capillary Isoelectric Focusing is a method which provides a charge profile of a heterogeneous mixture of variants within sample solution.

Size Exclusion Chromatography is a chromatographic method in which particles are separated based on their size or hydrodynamic volume.

Differential Scanning Calorimetry is a method which measures the difference in the amount of heat required to increase the temperature of a sample and reference are measured as a function of temperature.

Intrinsic Fluorescence is a method which provides information about the tertiary structure of proteins by monitoring the local environment of the aromatic amino acids.

Dynamic Light Scattering is a method which measures the time dependence of protein scattered light. Traditionally, this time dependence is processed to yield the hydrodynamic radius of a molecule.

The term “plurality” refers to a number of different test formulations in any given experiment. For example, depending upon the nature of the measurements performed the surface holding each formulation may be, but not limited to, transparent, opaque, solid white, solid grey, or solid black 96 well or 384 well plates. The nature of the measurements will determine the type of well or reservoir that may be used. For example, solid plates are recommended for fluorescent detection, white plates are recommended for luminescent detection, transparent, clear, or UV-plates are recommended for UV light detection. In one embodiment of the invention, half area plates (meaning that the volume requirement is less that whole area plates) with UV transparent bottom plates were used. It is anticipated that future improvements to solid surfaces will permit considerably larger such pluralities to be immobilized on a single surface. A “plurality of test formulations” refers to the use of one test formulation per well or reservoir on any one solid support. The solid support contains multiple wells or reservoirs that hold, for example, the test formulations, controls, or standards. In one embodiment, a plurality includes at least two wells or reservoirs per formulation experiment. In another embodiment, a plurality includes at least 4 wells or reservoirs per formulation experiment. In another embodiment, a plurality includes at least 10 wells or reservoirs per formulation experiment. In another embodiment, a plurality includes at least 48 wells or reservoirs per formulation experiment. In another embodiment, a plurality includes at least 96 wells or reservoirs per formulation experiment. In another embodiment, a plurality includes at least 192 wells or reservoirs per formulation experiment. In another embodiment, a plurality includes at least 384 wells or reservoirs per formulation experiment. In another embodiment, a plurality includes at least 1536 wells or reservoirs per formulation experiment. In another embodiment, a plurality includes at least 6144 wells or reservoirs per formulation experiment. The composition of the test formulations which make up an experimental run according to this invention may be selected or designed as desired.

The following examples are further illustrative of the present invention. This example is not intended to limit the scope of the present invention, and provides further understanding of the invention.

### EXAMPLES

The invention is further illustrated by way of the following examples which are intended to elucidate the invention. These examples are not intended, nor are they to be construed, as limiting the scope of the invention. Numerous modifications and variations of the present invention are possible in view of the teachings herein and, therefore, are within the scope of the invention. The examples below are carried out using standard techniques, and such standard techniques are well known and routine to those of skill in the art, except where otherwise described in detail.

### Example 1.1

### Determine First Tier DOE Design Using the Design Expert Software

In one embodiment of the invention, determine the first tier DOE design using the Design Expert software. This enables the following parameters to be determined (e.g. number and concentrations of buffers/excipients, maximum working volumes, number of experiments and contents of each well (randomized).

Factors and Ranges for the Design Include:
a. pH (4-7)
b. Sugar (yes or no)
   i. Sucrose (6-12%)
   ii. Trehalose (3-6%)
c. EDTA (0.05-0.2 mM)
d. Amino Acid (yes or no)
   i. Glycine (0-100 mM)
   ii. Arginine (0-100 mM)
e. NaCl (50-200 mM)

Analytical Responses:
a. SEC (size exclusion chromatography)
b. DLS (dynamic light scattering)
c. UV-Vis spectrophotometry
d. cIEF (capillary isoelectric focusing)

### Example 1.2

### Program a Robotic Liquid Handling System

In one embodiment of the invention, program a robotic liquid handling system, such as a TECAN® liquid robotic handling system.
a) Determine volumes of excipients/buffers to be added to each well in order to obtain desired DOE protein and excipient concentrations
b) Write a script (i.e. detailed computer instructions) for the preparation of buffer and filter plates

### Example 1.3

### Prepare Concentrated Buffer and Excipient Solutions

In another embodiment of the invention, concentrated buffer and excipient solutions for use by a robotic handling instrument are prepared.

### Example 1.4

### A robotic Liquid Handling System Prepares Appropriate Buffer Plates (see Example 2)

In another embodiment of the invention, a robotic liquid handling system prepares appropriate buffer plates as dictated by the script which is prescribed by DOE shown in Example 1.2.

### Example 1.5

### A Pre-Programmed Robotic Liquid Handling System Prepares Filter Plates (see Example 3)

In another embodiment of the invention, a pre-programmed robotic liquid handling system prepares filter plates (commercially available, 10K molecular weight cut-off) in which, about 10 mg/mL Mab, for example, is deposited into each well of the 96 well filter plate in its native buffer. TECAN adds appropriate buffers from prepared buffer plates to each well of 4 plates. The filter plates are placed into a 4-position centrifuge and spun as many times as necessary to ensure complete buffer exchange via pH measurements (see Example 1.7).

### Example 1.6

### Resuspend the Mab

In another embodiment of the invention, after the buffer exchange, the Mab in each well is resuspended by a robotic liquid handling system and brought up to a constant volume with the appropriate buffer/excipient solution for that well, for example.

### Example 1.7

### Determine MAb Concentration and pH

In another embodiment of the invention, Mab concentration via UV-Visible analysis and pH are determined.

### Example 1.8

### Stress Tests

In another embodiment of the invention, once Mab concentration is determined, a robotic liquid handling system is programmed to prepare separate plates for T=0 analysis by SEC, DLS and cIEF, if needed. Remaining Mab material from the filter plates is transferred to 96 well plates to be subjected to the stress condition of 50° C. for 1.5 days. The stress plates are reanalyzed by UV-Vis, SEC, cIEF and DLS to determine differences seen in the behavior of the Mab.

### Example 1.9

### DOE Data Analysis

In another embodiment of the invention, the stress data is entered into the DOE program for determination of lead formulations

### Example 2

### Preparation of Buffer Plates

In one embodiment of the invention, an Excel template was developed to import the DOE design from Design Expert and calculate the volume of each buffer, excipient or water needed for each well.

In another embodiment of the invention, a robotic liquid handling system is programmed to prepare the buffer plates by:
a. Aspirating water from a designated location and dispenses appropriate volumes determined by DOE design into wells on each 96 well buffer plate
b. Aspirating EDTA from a designated location and dispenses appropriate volumes determined by DOE design into wells on each 96 well buffer plate
c. Aspirating sugars from a designated location and dispenses appropriate volumes determined by DOE design into wells on each 96 well buffer plate
d. Aspirating buffer from a designated location and dispenses appropriate volumes determined by DOE design into wells on each 96 well buffer plate
e. Aspirating NaCl from a designated location and dispenses appropriate volumes determined by DOE design into wells on each 96 well buffer plate
f. Aspirating amino acid from a designated location and dispenses appropriate volumes determined by DOE design into wells on each 96 well buffer plate
g. Mix each well to ensure homogeneous buffer solutions.
h. Parafilm buffer plates until ready for use

### Example 3

### Preparation of Filter Plates for Buffer Exchange

In one embodiment of the invention, a robotic liquid handling system can be programmed to exchange Mab in native buffer with 96 (×4 plates) different formulation buffers:
a. Wash/hydrate filter plate
   i. Aspirate water from designated location and dispense into each 96 well filter plate
   ii. Transfer all 4 filter plates to centrifuge and spin
   iii. Remove plates from centrifuge
b. Place Mab on filter plate
   i. Aspirate Mab from designated location and dispense into each 96 well filter plate
   ii. Transfer all 4 filter plates to centrifuge and spin
   iii. Remove plates from centrifuge
   iv. Mix each well of each plate
c. Buffer Exchange (repeat at least 3 times)
   i. Aspirate buffer from designated location of each 96 well buffer plate prepared above and dispense into each corresponding filter plate
   ii. Mix each well of each filter plate
   iii. Transfer all 4 filter plates to centrifuge and spin
   iv. Remove plates from centrifuge

Filter plates are now used to make T=0 and stress assays plates.

### Example 4.1

### Determine Second Tier DOE Design Using the Design Expert Software

In one embodiment of the invention, determine the second tier DOE design using information obtained from first tier and Design Expert software. This enables the following parameters to be determined (e.g. number and concentrations of buffers/excipients, maximum working volumes, number of experiments and contents of each well (randomized)).

Factors and Ranges for the Design Include:
a. pH (±0.5 pH units of target)
b. Polysorbate 80 (0-0.1% w/v)
c. Buffer Species

Analytical Responses:
a. SEC (size exclusion chromatography)
b. DLS (dynamic light scattering)
c. UV-Vis spectrophotometry
d. cIEF (capillary isoelectric focusing)
e. Intrinsic Fluorescence
f. DSC (Differential Scanning Calorimetry)

### Example 4.2

### Program a Robotic Liquid Handling System

In one embodiment of the invention, program a robotic liquid handling system, such as a TECAN® liquid robotic handling system.
a) Determine volumes of excipients/buffers to be added to each well in order to obtain desired DOE protein and excipient concentrations
b) Write a script (i.e. detailed computer instructions) for the preparation of buffer and filter plates

### Example 4.3

### Prepare Concentrated Buffer and Excipient Solutions

In another embodiment of the invention, concentrated buffer and excipient solutions for use by a robotic handling instrument are prepared.

### Example 4.4

### A Robotic Liquid Handling System Prepares Appropriate Buffer Plates (see Example 5)

In another embodiment of the invention, a robotic liquid handling system prepares appropriate buffer plates as dictated by the script which is prescribed by DOE shown in Example 4.2.

### Example 4.5

### A Pre-Programmed Robotic Liquid Handling System Prepares Filter Plates (see Example 6)

In another embodiment of the invention, a pre-programmed robotic liquid handling system prepares filter plates (commercially available, 10K molecular weight cut-off) in which, about 10 mg/mL Mab, for example, is deposited into each well of the 96 well filter plate in its native buffer. TECAN adds appropriate buffers from prepared buffer plates to each well of 4 plates. The filter plates are placed into a 4-position centrifuge and spun as many times as necessary to ensure complete buffer exchange via pH measurements (see example 4.7).

### Example 4.6

### Resuspend the Mab

In another embodiment of the invention, after the buffer exchange, the Mab in each well is resuspended by a robotic liquid handling system and brought up to a constant volume with the appropriate buffer/excipient solution for that well, for example.

### Example 4.7

### Determine MAb Concentration and pH

In another embodiment of the invention, Mab concentration via UV-Visible analysis and pH are determined.

### Example 4.8

### Stress Tests

In another embodiment of the invention, once Mab concentration is determined, a robotic liquid handling system is programmed to prepare separate plates for T=0 analysis by SEC, DLS, and cIEF, if needed. Remaining Mab material from the filter plates is transferred to three separate 96 well plates. Each plate is subjected to one of the following conditions shear freeze-thaw or thermal stress (50° C. for 1.5 days). The stress plates are reanalyzed by UV-Vis, cIEF, Intrinsic Fluorescence, DSC, SEC and DLS to determine differences seen in the behavior of the Mab.

### Example 4.9

### DOE Data Analysis

In another embodiment of the invention, the stress data is entered into the DOE program for determination of lead formulations

### Example 5

### Preparation of Buffer Plates

In one embodiment of the invention, an Excel template was developed to import the DOE design from Design Expert and calculate the volume of each buffer, excipient or water needed for each well.

In another embodiment of the invention, a robotic liquid handling system is programmed to prepare the buffer plates by aspirating the appropriate excipient/buffer from a designated location and dispenses proper volumes determined by DOE design into wells on each 96 well buffer plate. Mix each well to ensure homogeneous buffer solutions.

### Example 6

### Preparation of Filter Plates for Buffer Exchange

In one embodiment of the invention, a robotic liquid handling system can be programmed to exchange Mab in native buffer with 96 different formulation buffers:
a. Wash/hydrate filter plate
   i. Aspirate water from designated location and dispense into each 96 well filter plate
   ii. Transfer all 4 filter plates to centrifuge and spin
   iii. Remove plates from centrifuge
d. Place Mab on filter plate
   i. Aspirate Mab from designated location and dispense into each 96 well filter plate
   ii. Transfer all 4 filter plates to centrifuge and spin
   iii. Remove plates from centrifuge
   iv. Mix each well of each plate
e. Buffer Exchange (repeat at least 3 times)
   i. Aspirate buffer from designated location of each 96 well buffer plate prepared above and dispense into each corresponding filter plate
   ii. Mix each well of each filter plate
   iii. Transfer all 4 filter plates to centrifuge and spin
   iv. Remove plates from centrifuge

Filter plates are now used to make T=0 and stress assays plates.

This invention is not to be limited in scope by the specific embodiments described herein. Indeed, various modifications of the invention in addition to those described herein will become apparent to those skilled in the art from the foregoing description. Such modifications are intended to fall within the scope of the appended claims. The disclosures of the patents, patent applications and publications cited herein are incorporated by reference in their entireties.

1. A method for determining formulations comprising,
a) dispensing a protein into a plurality wells of a filter plate;
b) providing a plurality of different test formulations;
c) performing buffer exchange by addition of the plurality of different test formulations to the wells of the filter plate;
d) simultaneously measuring multiple parameters and conditions of the protein; and
e) selecting at least one test formulation that maintains protein stability after a stress condition.

2. The method for determining formulations of claim 1, wherein the protein is a protein fragment.

3. The method for determining formulations of claim 1, wherein the protein is a monoclonal antibody.

4. The method for determining formulations of claim 1, wherein the plurality of different test formulations comprises at least 10 different formulations.

5. The method for determining formulations of claim 1, wherein the plurality of different test formulations comprises at least 48 different formulations.

6. The method for determining formulations of claim 1, wherein the plurality of different test formulations comprises at least 96 different formulations.

7. The method for determining formulations of claim 1, wherein the plurality of different test formulations comprises at least 384 different formulations.

8. The method for determining formulations of claim 1, wherein the plurality of different test formulations comprises at least 1536 different formulations.

9. A method for determining formulations comprising,
a) dispensing a first protein into a first set of a plurality wells of a filter plate;
b) dispensing a second protein into a second set of a plurality wells of a filter plate;
c) imputing formulation parameters into a statistical program to design a plurality of different test formulations;
d) providing a plurality of different test formulations via programming a robotic liquid handling system that manufactures a first set of a plurality of different test formulations and a second set of a plurality of different test formulations;
e) performing buffer exchange by addition of the plurality of different test formulations to the first and second sets of wells of the filter plates
f) simultaneously exposing the first set of a plurality of different test formulations containing protein to stress conditions;
g) simultaneously measure multiple parameters and conditions of the first set of a plurality of different test formulations containing protein after exposure to the stress conditions;
h) simultaneously measure multiple parameters and conditions of the second set of a plurality of different test formulations containing protein;
i) comparing the measurements from step f) to the measurements from step g); and j) selecting at least one test formulation that maintains protein stability after a stress condition.

10. The method claim 1, wherein the protein is dispensed at a concentration of about 10 mg/ml.

11. The method claim 1, wherein pH is measured in order to ensure complete buffer exchange

12. The method claim 1, wherein step b) comprises programming a robotic liquid handling system that manufactures the plurality of different test formulations.
